(19) United States
(12) Patent Application Publication
(10) Pub. No.: US 2006/0103843 A1
(43) Pub. Date: May 18, 2006

(54) Device and method for automatically calibrating an LCD panel

(75) Inventors: Jye-Jong Chen, Pin Chen City (TW); Bor-Ping Wang, Pin Chen City (TW)

Correspondence Address: BRUCE H. TROXELL, SUITE 1404, 5205 LEESBURG PIKE, FALLS CHURCH, VA, 22041, US

(73) Assignee: Optimax Technology Corporation

(21) Appl. No.: 10/989,352

(22) Filed: Nov. 17, 2004

(51) Int. Cl. G01J 4/00

(52) U.S. Cl. 356/364

(57) ABSTRACT

An LCD panel testing device and method thereof, wherein the LCD panel comprises in the sequence of a first polarizer, a first retardation plate, a liquid crystal unit, a second retardation plate, and a second polarizer. The LCD panel testing device includes: a light generation device, capable of providing a light source; a rotatory base, capable of supporting the LCD panel to form a proper angle with the direction of the light source, adjusting the relative phases of the first and the second retardation plates by rotating them, and substituting the first and the second retardation plates if necessary; a light detection unit, arranged according to the light generation device capable of detecting the light from the LCD panel; an optical signal examination device, connected with the light detection unit capable of examining the data from the light detection unit.

### FIELD OF THE INVENTION

The present invention relates to a device and a method for automatically calibrating an LCD panel, and more particularly, to an fast LCD auto-calibrating device and method thereof capable of adjusting and detecting the phase of the LCD panel automatically to meet with specific requirements by comparing the same to a standard specification.

### BACKGROUND OF THE INVENTION

A Liquid crystal display is a thin, lightweight display device with no moving parts. It consists of an electrically-controlled light-polarising liquid trapped in cells between two transparent polarising sheets. The polarising axes of the two sheets are aligned perpendicular to each other. Each cell is supplied with electrical contacts that allow an electric field to be applied to the liquid inside.

Liquid crystals exist in a state that is transitional between that of a solid or liquid. In this intermediate state, liquid crystal molecules tend to point the same way, like the molecules in a solid, but can also move around to different positions, like the molecules in a liquid. This tendency of the liquid crystal molecules to point along a certain direction results in the liquid crystal displaying certain properties that are specific to the direction to which these properties are measured. This fundamental property of liquid crystals, called anisotropy, is what is exploited in the engineering of LCDs. Liquid crystals can also be further categorized by their specific structure and properties, such as the twisted nematic (TN) LCD, the super-TN (STN) LCD, and the thin film transistor (TFT) LCD panels.

Please refer to FIG. 1, which is a schematic drawing of an LCD panel. The LCD panel 1 comprises successively a first polarizer 10, a first retardation plate 11, a liquid crystal monomer 12, a second retardation plate 13, and a second polarizer 14, wherein the polarising axes of the two polarizers 10, 14 are aligned perpendicular to each other, and a larger viewing angle can be obtained by rotating the first retardation plate 11 and the second retardation plate 13 for calibrating the relative phase so as to improve the optical compensation thereof to the optical characteristics of the liquid crystal monomer 12 and the polarizers.

Conventionally, the calibration is done by manually rotating the first 11 and the second retardation plates 13 for adjusting the relative phase thereof to a specific value, or by changing to the retardation plates of different wavelength and calibrating the same manually to match the specific value.

In view of the description above, the conventional method for calibration an LCD panel possesses at least the following disadvantages:
1. The calibration precision acquired by calibrating the relative phase of the retardation plates manually is poor, such that the calibration quality is not assured.
2. The production cost of calibrating the phases of retardation plates manually is high, and more man power are required by the same, such that the market competitiveness is reduced.
3. The repetitiveness of the manual calibration is poor, which the objective criteria are not assured to be the same for each calibration, such that the calibration quality and product reproducibility can not be assured.
4. The productivity is limited due to the conventional manual calibration method can not be automated.

### SUMMARY OF THE INVENTION

In view of the disadvantages in the prior art, the primary object of the present invention is to provide a device and a method for automatically calibrating an LCD panel, capable of improving the calibration precision and assuring the quality of the LCD panels produced.

The secondary object of the present invention is to provide a device and a method for automatically calibrating an LCD panel, capable of increasing the market competitiveness by simplifying the calibrating procedure and reducing the production cost.

Another object of the present invention is to provide a device and a method for automatically calibrating an LCD panel, capable of maintaining the same objective criteria in each calibration and therefore assuring the quality of the calibration and the reproducibility of the product.

Yet, another object of the present invention is to provide a device and a method for automatically calibrating an LCD panel, capable of increasing the productivity and reducing the production cost by automating the production.

To achieve the above objects, the present invention provides a device for automatically calibrating an LCD panel. The LCD panel comprises successively: a first polarizer, a first retardation plate, a liquid crystal monomer, a second retardation plate, and a second polarizer. The LCD calibration device includes: a light generation device, capable of providing a light source; a rotatory base, capable of carrying and orientating the LCD panel to form a proper angle between the same and an incident light from the light source, and adjusting the relative phase between the first and the second retardation plates by rotating the same, and optionally changing the first retardation plate and/or the second retardation plate if necessary; a light detection unit, arranged at a position corresponding to the light generation device for receiving/detecting the light emitted from the LCD panel, and an optical signal examination device, connected to the light detection unit, capable of examining the data of the light detection unit.

The LCD calibration device further comprises a comparison device that is arranged between the optical signal examination device and the rotatory base and provides a standard value to be compared with the data of the optical signal examination device. The standard value is acting as a base for calibrating the rotatory base.

In a method for automatically calibrating an LCD panel according to a preferred embodiment of the present invention, the LCD panel is arranged on a rotatory base, and the LCD panel comprises successively: a first polarizer, a first retardation plate, a liquid crystal monomer, a second retardation plate, and a second polarizer. The method comprises the steps of:
(a) orienting a light source for enabling the LCD panel to have a proper incident angle;
(b) detecting the light from the LCD panel to obtain a detection value;
(c) comparing the detection value with a standard value;
(d) calibrating the detection value to approach the standard value by rotating the rotary base to adjust the relative phase between the first retardation plate and the second retardation plate, and optionally changing the first retardation plate and/or the second retardation plate if necessary.

### BRIEF DESCRIPTION OF THE DRAWINGS

FIG. 1 is a schematic drawing of an LCD panel.

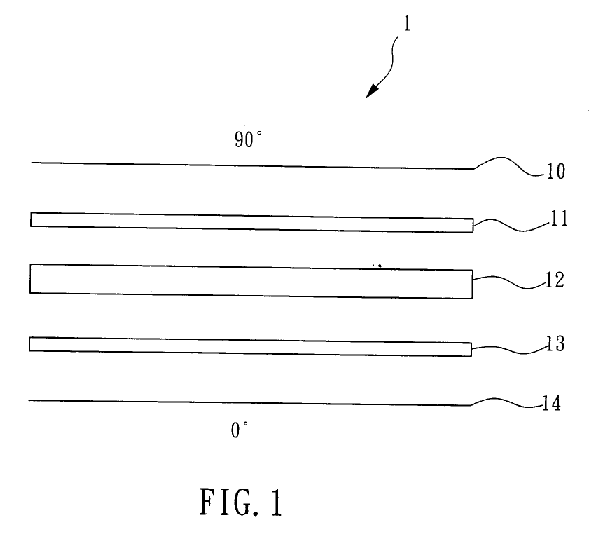

FIG. 2 is a schematic drawing of an LCD panel calibrating device depicting the first preferred embodiment of the present invention.

FIG. 3 is a schematic drawing of an LCD panel calibrating device depicting the second preferred embodiment of the present invention.

FIG. 4 is a schematic drawing of an LCD panel calibrating device depicting the third preferred embodiment of the present invention.

FIG. 5 is a flow chart of an LCD panel calibrating method according to a preferred embodiment of the present invention.

### DESCRIPTION OF THE PREFERRED EMBODIMENT

To make the esteemed review committee can further understand and recognize the present invention, a detailed description in accordance with several accompanying diagrams are presented as following.

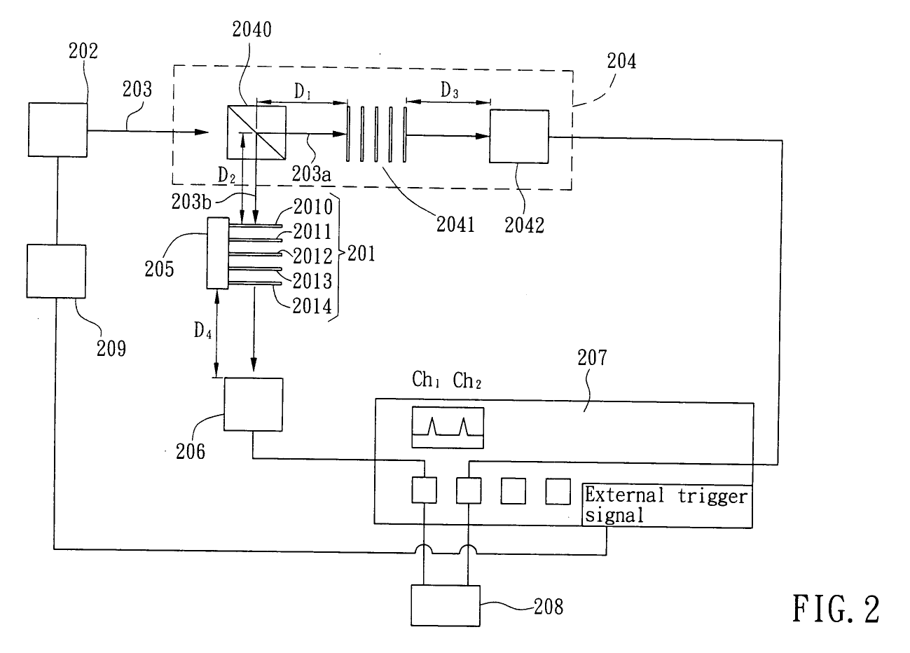

Please refer to FIG. 2, which is a schematic drawing of an LCD panel calibrating device depicting the first preferred embodiment of the present invention. The LCD panel 201 comprises successively: a first polarizer 2010, a first retardation plate 2011, a liquid crystal monomer 2012, a second retardation plate 2013, and a second polarizer 2014, and is a transmission type panel. A light generation device 202 is used to provide a light source 203 for the LCD panel calibrating device. In the present invention, the light generation device is a dye laser that generates visible light. With the high resolution, high intensity, and the monochromaticity, the wavelength of the light source 203 can be controlled in the range of 380 nm to 780 nm with a resolution of 0.01 nm, which falls into the wavelength range of a visible light so that the generated pattern can clearly be seen by the examiner.

The light source 203 is then passing through a comparison device 204, which includes: a beam splitter 2040, an sample LCD panel 2041, and a sample light detection device 2042, wherein the beam splitter 2040 is capable of splitting the light source 203 into light sources 203a and 203b with same intensities and same lengths of optical path (D₁=D₂). The light source 203a and the light source 203b are arranged to perpendicularly enter the sample LCD panel 2041 and the LCD panel 201 respectively, so that the objective criteria for the sample LCD panel 2041 and the LCD panel 201 will be under the same condition. The sample light detection unit 2042 arranged at the position corresponding to the beam splitter 2040 is then being used to detect the light from the light source 203a.

The light source 203b passes through the LCD panel 201 supported by the rotatory base 205 perpendicularly and is detected by a light detection unit 206. The optical path from the LCD panel 201 to the light detection unit 206 (D4) is equal to the optical path from the sample LCD panel 2041 to the sample light detection unit 2042 (D3). The data from the light detection unit 206 and the sample light detection unit 2042 are examined by connecting both the light detection unit 206 and the sample light detection unit 2042 to the optical signal examination device 207. Since the sample LCD panel 2041 has the specs that meet the required standard, the comparison device 204 is capable of providing a standard value Ch₂ to compare with the data Ch₁ of the testing LCD panel 201 from the optical signal examination device 207. Meanwhile, the rotatory base 205 is capable of adjusting the relative phases of the first 2011 and the second retardation plates 2013 by rotating them from 0 to 360 degrees, or optionally changing the first retardation plate 2011 and/or the second retardation plate 2013 if necessary, so that the data Ch₁ can approach the standard value Ch₂ hence the phase of the LCD panel 201 can achieve the required standard value.

The optical signal examination device 207 is connected with a recording device 208 for data recording. It is also connected to a digital retardation device by external trigger signals, and then to the light generation device 202 so as to synchronize the light generation device 202 with the optical signal examination device 207 for smoothing the calibration process. Typically, an oscilloscope is used as the examination device for the optical signal examination device 207, a computer or an integrator is used as the recording device 208, while a CCD, a CMOS, or a PMT is used as the light detection unit 206 and the sample light detection unit 2042. Since most of the elements are identical or similar to the preferred embodiment described hereinafter, the same name and numbering will be used for the identical elements, while the same name with an additional English alphabet attached will be used for the similar elements in the following preferred embodiments of the present invention.

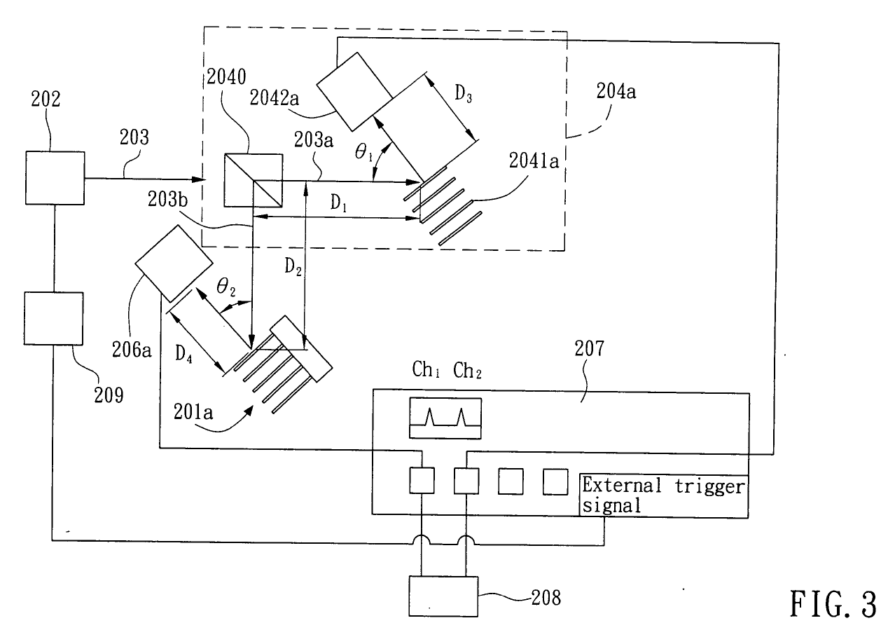

Please refer to FIG. 3, which is a schematic drawing of an LCD panel calibrating device depicting the second preferred embodiment of the present invention, wherein the LCD panel 201a and sample LCD panel 2041a are both reflection type panels. The reflection angle of the light source 203a from the sample LCD panel 2041a is and the reflection angle of the light source 201a from LCD panel 201a is, wherein , D₁=D, and D=D so that the testing criteria of the sample LCD panel 2041 a and the LCD panel 201a will be the same. The reflected light from the sample LCD panel 2041 a and the LCD panel 201 a are detected by the sample light detection unit 2042a and the light detection unit 206a respectively, which are examined and compared by the optical signal examination device 207. The principles of other elements are essentially the same as those described in the first preferred embodiment that further descriptions will therefore be omitted.

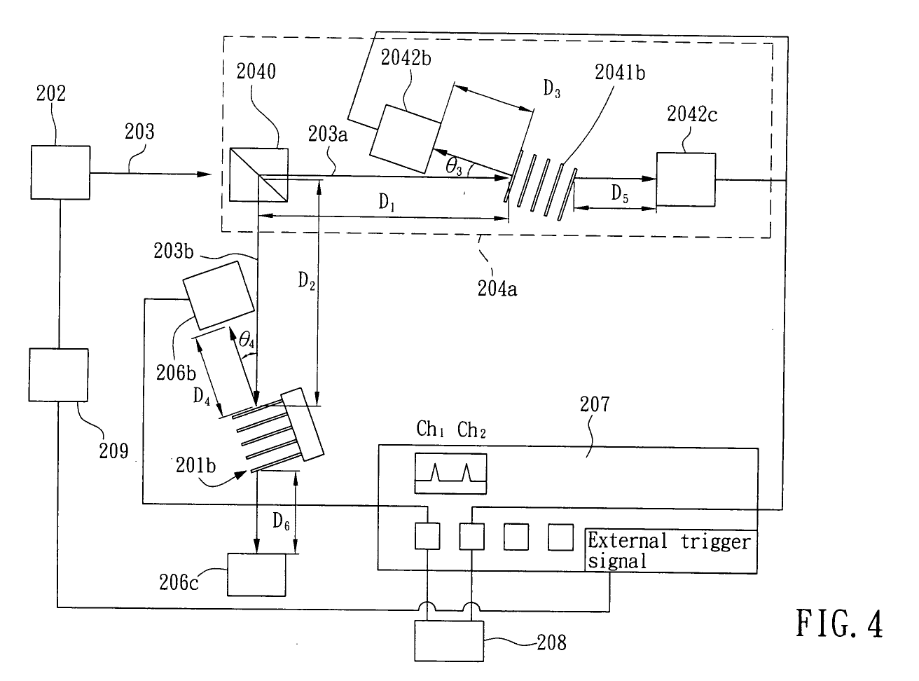

Please refer to FIG. 4, which is a schematic drawing of an LCD panel testing device depicting the third preferred embodiment of the present invention, wherein the LCD panel 201b and the sample LCD panel 2041b are both reflected-transmission (semi-reflected) type panels. The reflection angle of the light source 203a from the sample LCD panel 2041b is the optical path to the sample light detection unit 2042b is D, and the optical path after the light source 203a passes the sample LCD panel 2041b to the sample light detection unit 2042c is D; the reflection angle of the light source 203b from the LCD panel 201b is the optical path to the light detection unit 206b is D, and the optical path after the light source 203b passes the LCD panel 201b to the light detection unit 206c is D, wherein D₁=D, D=D, and D=D. As the result, the testing criteria of the sample LCD panel 2041b and the LCD panel 201b are identical. The reflected light from the sample LCD panel 2041b is detected by the sample light detection unit 2042b, the transmitted light from the sample LCD panel 2041b is detected by the sample light detection unit 2042c, while the reflected light from the LCD panel 201b is detected by the light detection unit 206b, and the transmitted light from the LCD panel 201b is detected by the light detection unit 206c. These four signals are monitored and examined by the optical signal examination device 207. The principles of other elements are essentially the same as those described in the first preferred embodiment, hence further descriptions are omitted here.

Apparently, the comparison devices in FIG. 2, FIG. 3, and FIG. 4 (204, 204a, 204b) can be eliminated by directly obtaining the standard value stored in a computer for examining and comparing.

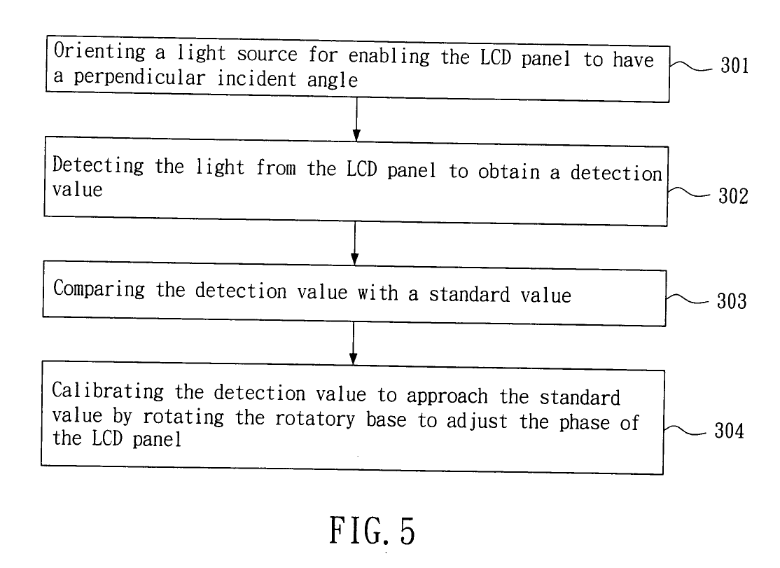

Please refer to FIG. 5, which is a flow chart of an LCD panel calibrating method according to a preferred embodiment of the present invention. The LCD panel is arranged on a rotatory base that the LCD panel comprises successively: a first polarizer, a first retardation plate, a liquid crystal unit, a second retardation plate, and a second polarizer. The method includes the following steps:
(a) Illuminating a light source onto the LCD panel perpendicularly, wherein the light source is a visible light with wavelength in the range of 380 nm to 780 nm that enables the resolution thereof to be 0.01 nm. Typically, a dye laser is used as the light generation device to generate the visible light.
(b) Detecting the light from the LCD panel to obtain a detection value, this is typically acquired by detecting the light from the LCD panel with a light detection unit and then converting into the numerical data with an oscilloscope. The types of light from the LCD panel are different according to the different types of the LCD panels being used. The light is a transmitted light if the LCD panel is a transmission type panel, the light is a reflected light if the LCD panel is a reflection type panel, while the light is a reflected-transmission light if the LCD panel is a reflected-transmission (semi-reflected) type panel.
(c) Comparing the detection value with a standard value, which is the spec defined by the company that can be obtained from an existing data base or from a sample directly.
(d) Calibrating the detection value to approach the standard value by rotating the rotatory base to adjust the phases of both the first retardation plate and the second retardation plate, or optionally changing the first retardation plate 2011 and/or the second retardation plate 2013 if necessary.

In summary, the LCD-panel calibrating device and method thereof of the present invention is capable of improving the calibration precision that assures the quality of the LCD panel, and simplifying the calibrating procedure to lower the production cost, and fixing the objective criteria in each calibration so as to automate the production and boost the productivity. While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

The invention may be embodied in other specific forms without departing from the spirit or essential characteristics thereof. The present embodiments is therefore to be considered in all respects as illustrative and not restrictive, the scope of the invention being indicated by the appended claims rather than by the foregoing description and all changes which come within the meaning and range of equivalency of the claims are therefore intended to be embraces therein.

What is claimed is:

1. A device for calibrating an LCD panel, the LCD panel comprising successively a first polarizer, a first retardation plate, a liquid crystal monomer, a second retardation plate, and a second polarizer, and the LCD panel calibrating device comprising:
a light generation device, capable of providing a light source;
a rotatory base, capable of carrying and orienting the LCD panel to form a specific angle between the same and the incident direction of the light source, and capable of respectively adjusting the phases of the first and the second retardation plate by rotating the same, and optionally changing the first retardation plate and optionally changing the second retardation plate if necessary;
a light detection unit, arranged at a position corresponding to the light generation device for detecting the light from the LCD panel; and
an optical signal examination device, connected to the light detection device for examining the data from the light detection unit.

2. The LCD panel calibrating device according to claim 1, the LCD panel calibrating device further comprising:
a comparison device, arranged between the optical signal examination device and the rotatory base, capable of providing a standard value to serve as a criterion for the rotatory base to adjust accordingly by comparing with the data detected by the optical signal examination device.

3. The LCD panel calibrating device according to claim 2, wherein the comparison device includes:
a sample LCD panel;
a beam splitter, capable of splitting the light source onto the sample LCD panel and the LCD panel with same intensities and optical path lengths;
a sample light detection unit, arranged at a position corresponding to the beam splitter, capable of detecting and receiving the light passing through the sample LCD panel.

4. The LCD panel calibrating device according to claim 1, wherein the light from the LCD panel is a transmitted light.

5. The LCD panel calibrating device according to claim 1, wherein the light from the LCD panel is a reflected light.

6. The LCD panel calibrating device according to claim 1, wherein the light from the LCD panel is a reflected-transmission light.

7. The LCD panel calibrating device according to claim 1, wherein the light generation device is a dye laser.

8. The LCD panel calibrating device according to claim 1, wherein the range of the wavelength of the light source is between 380 nm to 780 nm.

9. The LCD panel calibrating device according to claim 1, wherein the resolution of the light source formed is 0.01 nm.

10. The LCD panel calibrating device according to claim 1, wherein the light detection unit is a CCD.

11. The LCD panel calibrating device according to claim 1, wherein the light detection unit is a CMOS.

12. The LCD panel calibrating device according to claim 1, wherein the light detection unit is a PMT.

13. The LCD panel calibrating device according to claim 1, wherein the optical signal examination device is an oscilloscope.

14. The LCD panel calibrating device according to claim 1, wherein the optical signal examination device is connected to a recording device.

15. The LCD panel calibrating device according to claim 14, wherein the recording device is a computer.

16. The LCD panel calibrating device according to claim 14, wherein the recording device is an integrator.

17. A method for calibrating an LCD panel, the LCD panel being arranged on a rotatory base and comprising successively a first polarizer, a first retardation plate, a liquid crystal unit, a second retardation plate, and a second polarizer, the method including the steps of:
(a) illuminating a light source onto the LCD panel with a specific angle;
(b) detecting the light from the LCD panel to obtain a detection value.
(c) comparing the detected value with a standard value;
(d) calibrating the detection value to approach the standard value by rotating the rotatory base to adjust the phases of the first and the second retardation plates and optionally changing the first retardation plate and optionally changing the second retardation plate if necessary

18. The LCD panel calibrating method according to claim 17, wherein the light from the LCD panel is a transmitted light.

19. The LCD panel calibrating method according to claim 17, wherein the light from the LCD panel is a reflected light.

20. The LCD panel calibrating method according to claim 17, wherein the light from the LCD panel is a reflected-transmission light.

21. The LCD panel calibrating method according to claim 17, wherein the light source is generated by a dye laser.

22. The LCD panel calibrating method according to claim 17, wherein the range of the wavelength of the light source is between 380 nm to 780 nm.

23. The LCD panel calibrating method according to claim 17, wherein the resolution of the light source formed is 0.01 nm.
